(19) United States
(12) Patent Application Publication
(10) Pub. No.: US 2012/0231944 A1
(43) Pub. Date: Sep. 13, 2012

(54) Optical Glass

(76) Inventor: Akio Oogaki, Amagasaki-shi (JP)

(21) Appl. No.: 13/512,553

(22) PCT Filed: Sep. 15, 2010
(86) PCT No.: PCT/JP2010/065963

§ 371 Date: May 29, 2012

(30) Foreign Application Priority Data
Nov. 26, 2009 (JP) 2009 268611

(51) Int. Cl. C03C 3/064; C03C 3/068

(52) U.S. Cl. 501/78; 501/77

(57) ABSTRACT

The disclosed optical glass contains, by weight, 20-32% SiO₂, 6-10% Li₂O (exclusive of 6%), 3-18% Na₂O, 3-20% K₂O, 8-30% TiO₂, 10-55% Nb₂O₅, 0.3-3% B₂O₃, 0-3% Gd₂O₃, 0-3% Y₂O₃, 0-3% La₂O₃ (with Gd₂O₃+Y₂O₃+La₂O₃≧0.5%), 0-2% Bi₂O₃, 0-2% WO₃, 0-2% SnO₂, and has a refractive index (nd) of 1.78-1.85, and an Abbe number (vd) of 23-35.

### TECHNICAL FIELD

The present invention relates to optical glasses. More particularly, the present invention relates to optical glasses suitable for liquid-drop molding, and to optical elements made of such optical glasses.

### BACKGROUND ART

One known method of molding glass is liquid-drop molding. Liquid-drop molding is a method in which glass is dripped through a nozzle directly into a mold and is pressed into the final shape (including a plate method). In this method, the nozzle temperature is controlled, and thereby the glass temperature is controlled; the viscosity of the glass is thereby controlled, and thereby the size of the drops of the dripping glass is controlled

As glass that can be used in liquid-drop molding, for example, Patent Document 1 listed below discloses an optical glass containing substantially no phosphates which contains, by weight, 20% to 45% of SiO₂, 0.5% to 6% of Li₂O, 3% to 18% of Na₂O, 18% or more but less than 25% of TiO₂, 1% to 42% of Nb₂O₅, 0% to 4% of CaO, and 0% to 4.5% of B₂O₃ and which has a refractive index (nd) of 1.63 to 1.75. Patent Document 1 also discloses an optical glass containing substantially no phosphates which contains, by weight, 24% to 32% of SiO₂, 0.5% to 6% of Li₂O, 3% to 18% of Na₂O, 12% to 30% of TiO₂, 1% to 42% of Nb₂O₅, 0% to 4% of CaO, and 0% to 4.5% of B₂O₃ and which has a refractive index nd of 1.75 to 1.85. Patent Document 1 further discloses optical glasses having Abbe numbers of 23 to 35, and those having liquid phase temperatures (TL) of 1000° C. or less.

### LIST OF CITATIONS

### Patent Literature

Patent Document 1: JP-A-2002-87841

### SUMMARY OF INVENTION

### Technical Problem

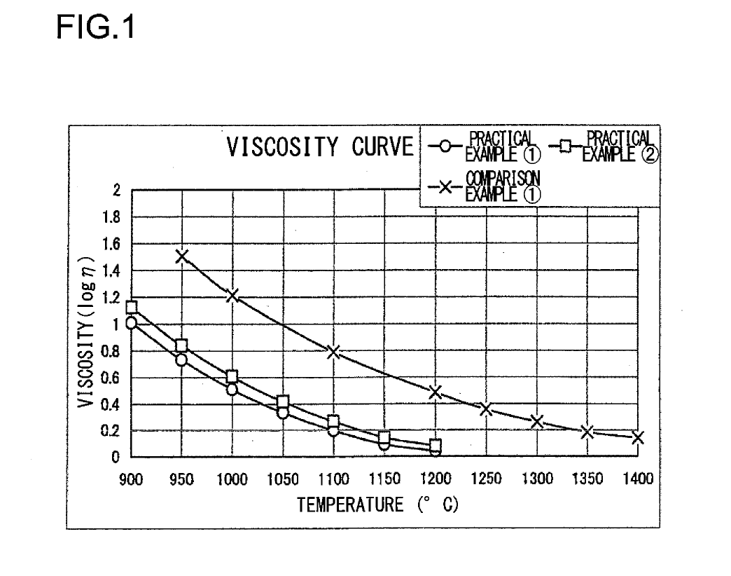

For glass to be suitable for liquid-drop molding, its viscosity in terms of log η (dPa·s) needs to be largely in the range of 0.15 to 0.80, through depending on the shape of the optical element to be fabricated. The viscosity of glass depends on its temperature, decreasing as temperature rises and increasing as temperature falls. Raising the glass temperature causes the temperature of the drops of the dripping glass to rise accordingly, and this inconveniently shortens the life of the press mold. It is therefore preferable that glass have a viscosity log η in the range of 0.15 to 0.80 at as low a temperature as possible. For example, testing with the glass of Example 14 of Patent Document 1 revealed that it exhibited a viscosity log η of 0.15 only when it was heated to as high as 1390° C. (see FIG. 1). In contact with drops of molten glass at such a high temperature, the press mold deteriorates notably, inconveniently shortening the life of press mold greatly.

It is preferable that glass have a liquid phase temperature (TL) such that it does not devitrify at the temperature at which it has a viscosity log η of 0.80. A high liquid phase temperature (TL) causes devitrification in the nozzle, and makes stable formation of liquid drops difficult; it is undesirable also because, in a case where P₂O₅ is contained as a glass ingredient, it makes this glass ingredient more likely to adhere to the mold. Moreover, to alleviate the burden on the working environment during fabrication, it is desired that none of the following substances be contained: lead compounds; fluorine and its compounds; tellurium compounds; arsenic compounds classified as poisonous under the Poisonous and Deleterious Substances Control Act; antimony compounds and barium compounds classified as deleterious under the same act. That is, it is desirable to make no use of any of these substances.

The present invention has been devised against the above background, and aims to provide optical glasses suitable for liquid-drop molding which contain no P₂O₅ or like ingredients, which have a viscosity log η of 0.15 at a low glass temperature (specifically, having a viscosity log η of 0.15 at a temperatures of 1190° C. or less, and having a liquid phase temperature (TL) lower than the temperature at which they have a viscosity log η of 0.80), which have a refractive index in the range of 1.78 to 1.85, and which have an Abbe number (vd) in the range of 23 to 35, and to provide optical elements made of such optical glasses.

### Solution to Problem

With glass based on SiO₂—TiO₂—Nb₂O₅—R₂O (where R is one or more of Li, Na, and K), it is normally easy to reduce viscosity by using alkaline ingredients such as Li₂O, Na₂O, and K₂O in large amounts, and this fact is well known. Such use of alkaline ingredients in large amounts, however, is accompanied by a side effect of extremely raising the liquid phase temperature (TL) of glass, and thus makes it difficult to obtain stable glass. The present inventor has found that it is possible to suppress the rise in TL resulting from the use of alkaline ingredients such as Li₂O in large amounts by combined use of B₂O₃ with one or more of Gd₂O₃, Y₂O₃, and La₂O₃ in adequate amounts. This finding has led the inventor to the present invention.

Specifically, according to a first aspect of the invention, an optical glass contains, by weight: 20% to 32% of SiO₂; 6% to 10% of Li₂O (6% exclusive); 3% to 18% of Na₂O; 3% to 20% of K₂O; 8% to 30% of TiO₂; 10% to 55% of Nb₂O₅; 0.3% to 3% of B₂O₃; 0% to 3% of Gd₂O₃; 0% to 3% of Y₂O₃; 0% to 3% of La₂O₃, Gd₂O₃+Y₂O₃+La₂O₃≧0.5%; 0% to 2% of Bi₂O₃; 0% to 2% of WO₃; and 0% to 2% of SnO₂. Here, the glass has a refractive index (nd) in the range of 1.78 to 1.85 and an Abbe number (vd) in the range of 23 to 35. In the present specification, unless otherwise stated, “%” stands for “percent by weight.”

According to a second aspect of the invention, in the optical glass of the first aspect described above, the glass has a viscosity log η of 0.15 at a temperature of 1160° C. or less, and has a liquid phase temperature (TL) lower than the temperature at which it has a viscosity log η of 0.8.

According to a third aspect of the invention, in the optical glass of the first or second aspect described above, the liquid phase temperature (TL) is 930° C. or less.

According to a fourth aspect of the invention, an optical element is formed by liquid-drop molding of the optical glass of any one of the first to third aspects described above as a material for liquid-drop molding.

### Advantageous Effects of the Invention

Optical glasses according to the present invention contain predetermined glass ingredients in predetermined amounts, and this helps realize glass materials that are suitable for liquid-drop molding and that have low viscosity and low liquid phase temperatures. In addition, optical glasses according to the invention do not contain any of lead compounds, fluorine and its compounds, tellurium compounds, arsenic compounds, antimony compounds, and barium compounds, and this helps alleviate the burden on the working environment during fabrication. Optical elements according to the invention are fabricated by liquid-drop molding of optical glasses as described above, and thus they, while having the properties of those optical glasses, contribute to high productivity and low costs.

### BRIEF DESCRIPTION OF DRAWINGS

[FIG. 1] is a graph showing the viscosity curves of Practical Examples 1 and 2 and Comparison Example 1.

### DESCRIPTION OF EMBODIMENTS

Hereinafter, as to the ranges of the contents of different ingredients in optical glasses according to the present invention, the reasons for restricting them as noted above will be described along with other features.

The contents of essential ingredients are as follows: 20% to 32% of SiO₂, 6% to 10% of Li₂O (6% exclusive), 3% to 18% of Na₂O, 3% to 20% of K₂O, 8% to 30% of TiO₂, 10% to 55% of Nb₂O₅, 0.3% to 3% of B₂O₃, 0% to 3% of Gd₂O₃, 0% to 3% of Y₂O₃, and 0% to 3% of La₂O₃, where Gd₂O₃+Y₂O₃+La₂O₃≧0.5%. The contents of optional ingredients are as follows: 0% to 2% of Bi₂O₃, 0% to 2% of WO₃, and 0% to 2% of SnO₂.

SiO₂ is an ingredient which forms glass. A SiO₂ content less than 20% makes the glass unstable, but a SiO₂ content more than 32% makes it difficult to obtain the desired optical constants. A preferred range of the SiO₂ content is 23% to 28%.

Li₂O is the most effective ingredients in giving glass low viscosity as desired. A Li₂O content of 6% or less is not effective enough to obtain the desired viscosity, but a Li₂O content more than 10% makes the glass prone to devitrification. A preferred range of the Li₂O content is 7% to 9%.

Na₂O and K₂O also are essential ingredients. Using 3% or more of each of Na₂O and K₂O in combination with Li₂O has the effect of lowering the liquid phase temperature (TL). To obtain the desired refractive index (nd), it is preferable that the Na₂O content be 18% or less. A preferred range of the Na₂O content is 4% to 8%. K₂O makes glass more volatile during melting, and it is preferable that the K₂O content be 20% or less. A preferred range of the K₂O content is 5% to 12%.

B₂O₃ and Ln₂O₃ (where Ln stands for one or more of Gd, Y, and La) are essential ingredients. Simply using Li₂O, Na₂O, and K₂O in amounts in proper ranges does not sufficiently lower the liquid phase temperature (TL). Using B₂O₃ and Ln₂O₃ in combination makes it possible to lower the liquid phase temperature (TL) to 930° C. or less. B₂O₃ is an ingredient which is effective in lowering the liquid phase temperature (TL). A B₂O₃ content less than 0.3% does not provide that effect sufficiently, but a B₂O₃ content more than 3% increases volatilization during melting and makes striae (cords) likely to develop, and therefore it is preferable that the B₂O₃ content be 3% or less. A preferred range of the B₂O₃ content is 0.3% to 1.5%.

Gd₂O₃, Y₂O₃, and La₂O₃ are all ingredients that are, when combined with B₂O₃, effective in lowering the liquid phase temperature (TL). A content less than 0.5% of one or two or more of those three ingredients does not provide the effect sufficiently; a content of 0.5% or more provides the effect of lowering the liquid phase temperature (TL). By contrast, a content more than 3% of any of Gd₂O₃, Y₂O₃, and La₂O₃ raises the liquid phase temperature (TL) and is therefore undesirable.

TiO₂ is an essential ingredient which gives glass a high refractive index. A TiO₂ content of 8% or more but 30% or less provides a refractive index (nd) in the range of 1.78 to 1.85.

Nb₂O₅ is an essential ingredient which achieves a high refractive index and high dispersion. A Nb₂O₅ content of 10% to 55% provides a refractive index (nd) in the range of 1.78 to 1.85 and an Abbe number (vd) in the range of 23 to 35.

Any of the optional ingredients, Bi₂O₃, WO₃, and SnO₂, may be substituted for Nb₂O₅ etc. to adjust the refractive index, but a content more than 2% of any of them degrades the liquid phase temperature (TL).

Restricting the ranges of the contents of different ingredients as described above makes it possible to realize optical glasses that are suitable for liquid-drop molding and that have low viscosity and low liquid phase temperatures. Moreover, these optical glasses do not contain any of lead compounds, fluorine and its compounds, tellurium compounds, arsenic compounds, antimony compounds, and barium compounds, and thus alleviate the burden on the working environment during fabrication. It is preferable that these optical glasses have a viscosity log η of 0.15 at a temperature of 1160° C. or less and have a liquid phase temperature (TL) lower than the temperature at which they have a viscosity log η of 0.8, and it is further preferable that they have a liquid phase temperature (TL) of 930° C. or less.

Optical elements according to the invention are fabricated by liquid-drop molding of optical glasses as described above. This method eliminates the need for grinding and polishing processes, leading to improved productivity, and makes it possible to obtain optical elements having difficult-to-form shapes, such as ones having free-form curved surfaces and aspherical surfaces, contributing to high productivity and low costs.

### EXAMPLES

Hereinafter, the composition and other features of optical glasses according to the invention will be described in more detail by way of, among others, Practical Examples 1 to 8 and Comparison Examples 1 and 2. Comparative Example 1 corresponds to Example 14 of Patent Document 1 mentioned earlier.

First, common source materials for glass, such as oxides, carbonates, and nitrates, were blended to be mixed into blended materials having different target compositions (in percent by weight) as shown in Tables 1 and 2. Each of these blended materials was placed in a melting furnace heated to 1100° C. to 1300° C., where it was melted and stirred, and was then, after clarifying, dripped into a preheated mold or the like and then slowly cooled to produce a sample. Each sample was tested for its refractive index for the d-line (nd), Abbe number (vd), liquid phase temperature (TL), and viscosity (log η). The results of the tests are shown together in Table 1 (Practical Examples 1 to 8), Table 2 (Comparison Examples 1 and 2), and FIG. 1 (Practical Examples 1 and 2, and Comparison Example 1).

(1) Refractive index (nd) and Abbe number (vd)

As mentioned above, the molten glass dripped into the mold was cooled slowly down to room temperature at a rate of −20° C./hour. Each sample was tested on a “KPR-2000” precision refractometer manufactured by Shimadzu Device Corporation.

(2) Liquid phase temperature (TL) was determined by keeping each sample for one hour in a devitrification testing furnace with a temperature slope of 700° C. to 1100° C., then taking it out of it, and then inspecting it for presence of devitrification on a microscope at a magnification of 40×.

(3) Viscosity (log η) at different temperatures was measured on a high-temperature viscosity tester of a rotation type.

TABLE 1
Practical Examples

| | No | | | | | | | |
|---|---|---|---|---|---|---|---|---|
| | \textcircled{1} | \textcircled{2} | \textcircled{3} | \textcircled{4} | \textcircled{5} | \textcircled{6} | \textcircled{7} | \textcircled{8} |
| SiO2 | 25.7 | 25.5 | 25.5 | 25.2 | 25.5 | 25.5 | 25.5 | 25.5 |
| Li2O | 8.0 | 7.0 | 8.0 | 7.0 | 7.0 | 7.0 | 7.0 | 7.0 |
| Na2O | 5.0 | 4.0 | 4.0 | 4.0 | 4.0 | 4.0 | 4.0 | 4.0 |
| K2O | 8.0 | 9.0 | 9.0 | 9.0 | 9.0 | 9.0 | 9.0 | 9.0 |
| TiO2 | 12.0 | 15.1 | 12.0 | 16.0 | 16.0 | 17.0 | 16.0 | 15.0 |
| Nb2O5 | 40.5 | 37.7 | 40.5 | 36.0 | 36.5 | 35.3 | 36.0 | 37.7 |
| B2O3 | 0.3 | 0.5 | 0.5 | 0.8 | 0.5 | 0.5 | 0.5 | 0.5 |
| Gd2O3 | 0.5 | 0.7 | | 1.0 | 0.5 | 0.8 | | 0.8 |
| Y2O3 | | 0.5 | 0.5 | | 0.5 | 0.4 | 0.8 | |
| La2O3 | | | | | | | 0.2 | |
| Gd2O3 + | 0.5 | 1.2 | 0.5 | 1.0 | 1.0 | 1.2 | 0.7 | 0.8 |
| Y2O3 + | | | | | | | | |
| La2O3 | | | | | | | | |
| Bi2O3 | | | | | 0.5 | 0.5 | 0.5 | 0.5 |
| WO3 | | | | 0.5 | | | 0.5 | |
| SnO2 | | | | 0.5 | | | | |
| | 100.0 | 100.0 | 100.0 | 100.0 | 100.0 | 100.0 | 100.0 | 100.0 |
| TOTAL | | | | | | | | |
| nd | 1.8052 | 1.8139 | 1.8052 | 1.8132 | 1.8155 | 1.8172 | 1.8160 | 1.8138 |
| νd | 26.8 | 25.9 | 26.8 | 25.9 | 25.8 | 25.6 | 25.7 | 25.9 |
| TEMPERATURE | 1120 | 1140 | 1120 | 1130 | 1140 | 1140 | 1130 | 1140 |
| WHEN | | | | | | | | |
| log η = 0.15 | | | | | | | | |
| TEMPERATURE | 940 | 960 | 940 | 950 | 960 | 960 | 950 | 960 |
| WHEN | | | | | | | | |
| log η = 0.80 | | | | | | | | |
| TL (° C.) | 890 | 880 | 900 | 920 | 910 | 920 | 920 | 910 |

TABLE 2
Comparison Examples

| | \textcircled{1} | \textcircled{2} |
|---|---|---|
| SiO2 | 31.0 | 26.0 |
| Li2O | 5.0 | 6.0 |
| Na2O | 5.0 | 5.0 |
| K2O | 5.0 | 10.0 |
| TiO2 | 18.0 | 12.0 |
| Nb2O5 | 36.0 | 41.0 |
| B2O3 | | |
| Gd2O3 | | |
| Y2O3 | | |
| La2O3 | | |
| Gd2O3 + | | |
| Y2O3 + | | |
| La2O3 | | |
| TOTAL | 100.0 | 100.0 |
| nd | 1.826 | DEVITRIFIED DURING |
| νd | 23.1 | MELTING |
| TEMPERATURE | 1390 | |
| (° C.) WHEN | | |
| log η = 0.15 | | |
| TEMPERATURE | 1100 | |
| (° C.) WHEN | | |
| log η = 0.80 | | |
| TL(° C.) | 950 | |

The results above reveal the following. With Practical Examples 1 to 8 (Table 1), the glass viscosity log η was 0.15 at temperature of 1160° C. or less, and the liquid phase temperature (TL) was 930° C. or less, which was lower than the temperature at which the viscosity log η was 0.8. By contrast, with Comparison Example 1 (Table 2), the glass viscosity log η was 0.15 at temperature of 1160° C. or more, and the liquid phase temperature (TL) was 930° C. or more; Comparison Example 2 (Table 2) exhibited devitrification during melting.

1.-4. (canceled)

5. An optical glass comprising, by weight:
20% to 32% of SiO₂;
6% to 10% of Li₂O (6% exclusive);
3% to 18% of Na₂O;
3% to 20% of K₂O;
8% to 30% of TiO₂;
35% to 41% of Nb₂O₅;
0.3% to 3% of B₂O₃;
0% to 3% of Gd₂O₃;
0% to 3% of Y₂O₃;
0% to 3% of La₂O₃,
Gd₂O₃+Y₂O₃+La₂O₃≧0.5%;
0% to 2% of Bi₂O₃;
0% to 2% of WO₃; and
0% to 2% of SnO₂, wherein
the glass has a refractive index (nd) in a range of 1.78 to 1.85 and an Abbe number (vd) in a range of 23 to 35.

6. The optical glass according to claim 5, comprising 23% to 28% by weight of SiO₂.

7. The optical glass according to claim 5, comprising 7% to 9% by weight of Li₂O.

8. The optical glass according to claim 5, comprising 4% to 8% by weight of Na₂O.

9. The optical glass according to claim 5, comprising 5% to 12% by weight of K₂O.

10. The optical glass according to claim 5, comprising 0.3% to 1.5% by weight of B₂O₃.

11. The optical glass according to claim 5, wherein
the glass has a viscosity log η of 0.15 at a temperature of 1160° C. or less, and
the glass has a liquid phase temperature (TL) lower than a temperature at which the glass has a viscosity log η of 0.8.

12. The optical glass according to claim 5, wherein
the liquid phase temperature (TL) is 930° C. or less.

13. The optical glass according to claim 11, wherein
the liquid phase temperature (TL) is 930° C. or less.

14. An optical element formed by liquid-drop molding of the optical glass according to claim 5 as a material for liquid-drop molding.

15. An optical element formed by liquid-drop molding of the optical glass according to claim 11 as a material for liquid-drop molding.

16. An optical element formed by liquid-drop molding of the optical glass according to claim 12 as a material for liquid-drop molding.

17. An optical element formed by liquid-drop molding of the optical glass according to claim 13 as a material for liquid-drop molding.
